(19) United States
(12) Patent Application Publication
(10) Pub. No.: US 2001/0024745 A1
(43) Pub. Date: Sep. 27, 2001

(54) Device for the selective catalytic oxidation of carbon monoxide

(76) Inventors: Alexandra Hassert, Wangen (DE); Marco Lippert, Bibertal-Buhl (DE); Martin Schussler, Ulm (DE); Matthias Wolfsteiner, Kirchheim (DE)

Correspondence Address: EVENSON, MCKEOWN, EDWARDS &, LENAHAN, P.L.L.C., Suite 700, 1200 G Street, N.W., Washington, DC, 20005, US

(21) Appl. No.: 09/741,910

(22) Filed: Dec. 22, 2000

(30) Foreign Application Priority Data
Dec. 23, 1999 (DE) 199 62 555.7

(51) Int. Cl. H01M 8/06; B01J 8/02

(52) U.S. Cl. 429/19; 422/211

(57) ABSTRACT

A device for the selective catalytic oxidation of carbon monoxide contained in a hydrogenous gas mixture flow includes at least one CO oxidation stage having at least one inlet opening for feeding oxidizing gas to the gas mixture flow. At least one flow-through body containing a catalyst is arranged in the gas mixture flow in the CO oxidation stage. The flow-through body fills a flow-through cross section of the gas mixture flow in the CO oxidation stage. The device also contains means for pre-setting the temperature of the body as a function of the load.

### BACKGROUND AND SUMMARY OF INVENTION

This application claims the priority of German application No. 199 62 555.7, filed Dec. 23, 1999, the disclosure of which is expressly incorporated by reference herein.

The present invention relates to a device for the selective catalytic oxidation of carbon monoxide.

DE 195 44 895 C1 discloses a device with which a variable process control, adaptable to a respective situation, is possible. A gas containing carbon monoxide and an additional oxidizing gas are passed through a reactor containing catalyst material. It is proposed to introduce the oxidizing gas, in each case with either a controlled or regulated rate of flow, at multiple points along the gas mixture flow path. It is also proposed to cool the gas mixture flow passively by means of static mixer structures arranged in the inlet area of the CO oxidation reactor.

In fuel cell systems used in vehicles, high system dynamics are desirable. With the requisite load spread, at partial load carbon monoxide reforms in the CO oxidation reactors due to a so-called reverse-shift reaction. Although this can be counteracted by multistage CO oxidation units, this has an unfavourable effect on the mass, volume, and costs of the device.

The object of the present invention is to create a device in which a selective oxidation of carbon monoxide can be easily and compactly performed with high dynamics.

This object is achieved in a device for the selective catalytic oxidation of carbon monoxide according to the present invention.

The CO oxidation stage according to the present invention has at least one flow-through body containing catalyst in the gas mixture flow. The flow-through body fills a cross-section of the gas mixture flow in the CO oxidation stage. Means are provided for pre-setting the temperature of the body as a function of the load.

According to the present invention, the temperature of the catalytically active area can be varied as a function of the load. The temperature can be reduced by adding less oxygen to the gas mixture flow, and the temperature can be increased by adding more oxygen. The higher the desired dynamics of the CO oxidation stage, the lower the thermal mass of the catalytically active area should be set. The temperature adjustment can thereby be performed with sufficient rapidity.

Other objects, advantages and novel features of the present invention will become apparent from the following detailed description of the invention when considered in conjunction with the accompanying drawings.

### BRIEF DESCRIPTION OF THE DRAWINGS

FIG. 1. shows a section from a fuel cell system; and

FIG. 2 shows the CO oxidation stage of FIG. 1.

### DETAILED DESCRIPTION OF THE DRAWINGS

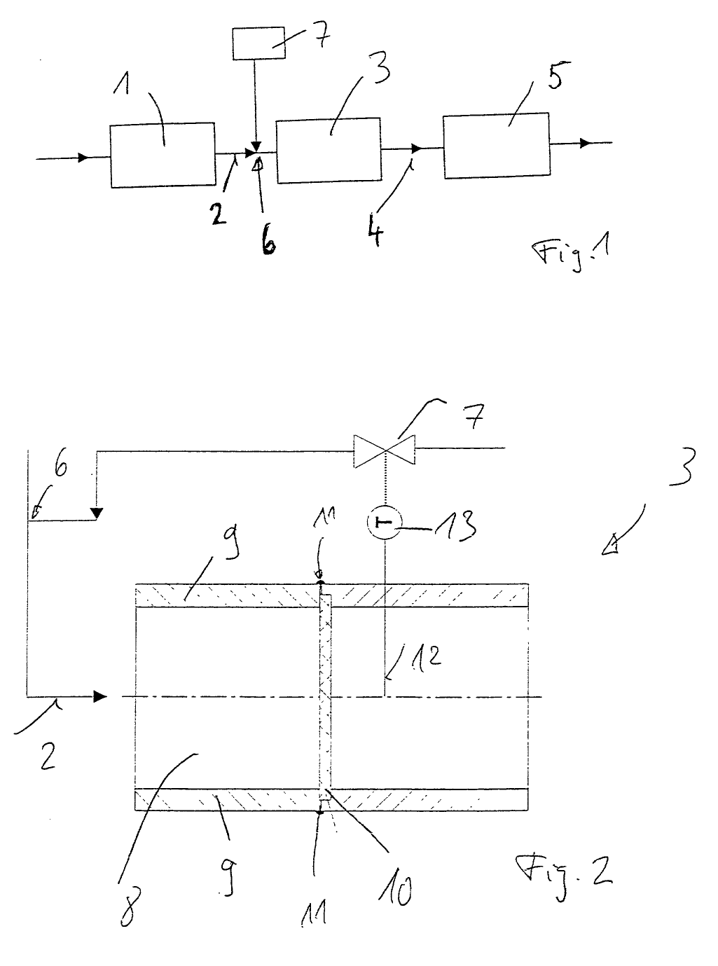

A device according to the present invention using the example of a section from a fuel cell system is represented in FIG. 1. Further details of the fuel cell system are not shown.

From a reformer 1, a gas mixture flow passes by way of a flow line 2 into a CO oxidation stage 3. The gas mixture flow contains carbon monoxide CO and hydrogen. CO is removed from the gas mixture flow in the CO oxidation stage 3. The cleaned gas mixture flow is then fed by way of a flow line 4 to a fuel cell 5. An oxidizing medium, preferably air, is added to the gas mixture flow by way of a metering device 7 on the inlet flow side of the CO oxidation stage 3 or in the CO oxidation stage 3 by way of an inlet opening 6. A plurality of CO oxidation stages may also be provided in the system.

A preferred embodiment of a CO oxidation stage 3 is represented in FIG. 2. The CO oxidation stage 3 is designed as a pipe, but may also be a plate reactor arrangement or some other form of reactor. The flow-through chamber 8 is defined by walls 9. The gas mixture flows out of the reformer by way of the line 2 into the CO oxidation stage 3. At the same time a metered flow of an oxidizing medium, preferably air, is added at the inlet opening 6. The gas mixture flows through body 10, which fills the cross section of the flow path of the gas mixture in the CO oxidation stage 3. The flow-through body 10 has a catalytic effect and converts the carbon monoxide in the preferably hydrogenous gas mixture flow, selectively and catalytically.

The flow-through body is characterized by a very low thermal mass or low thermal capacity, so that it can react very rapidly to temperature changes.

The mass of the catalyst carrier is preferably selected so that, within the dynamics required by the system, a predetermined temperature adjustment can be achieved by a corresponding metered addition of an oxidizing gas. The temperature is adjusted in such a way that an exothermic reaction occurs and the temperature rises as a result of an increase in the metered addition. The exothermic reaction ceases and the temperature falls as a result of a decrease in the metered addition.

In the case of a catalyst carrier, preferably a metal fleece containing catalyst, the maximum mass of metal, for example steel, for a reformate flow of approximately 100 standard m³/h, is advantageously 10 to 200 g. Adequate dynamics can be obtained with this low thermal mass of the catalyst carrier. The mass of the catalyst itself is low and can be disregarded. A low thermal capacity in the range of 5-100 Joule/Kelvin corresponds to the low thermal mass.

At the same time, the optimum design of the flow-through body 10 must be adapted to the respective installation point of the CO oxidation stage, since the thermal load may vary in different stages.

In addition, the flow-through body 10 must be insulated from the walls 9 of the CO oxidation stage 3 by thermal insulation 11, or at least connected in such a way that any heat input from the walls 9 or heat dissipation via the walls 9 is reduced. Measures suited to this purpose will be familiar to one skilled in the art.

In the catalytic selective reaction, heat is produced. Thus, the temperature of the gas mixture flow downstream of the flow-through body 10 represents a measure of the conversion of the carbon monoxide. The temperature can be determined by a temperature sensor 12 downstream of the body 10, and an actuator 13 acts on the metering device 7 such that an oxidizing medium is added to the gas mixture flow as a function of the load. The temperature of the catalytically active area or the flow-through body 10 can thereby be varied and preferably pre-set as a function of the load. The temperature is adjusted by adjusting the oxygen content of the educt fed in to CO oxidation stage. This can be achieved by means of an open or closed loop control. The quantity of oxygen is pre-set as a function of the load that the reactor or the flow-through body 10 has to handle. The quantity of oxygen to be fed in can be controlled by sensor 12. The quantity of oxygen to be fed in for a certain load can also be controlled without a sensor.

The flow-through body 10 is preferably formed from fabrics, such as fleece, interwoven fabric, or cloth coated with catalyst material, or also by a catalyst packing of low thermal mass. The temperature of the catalytically active area can therefore be adjusted very rapidly.

The higher the system dynamics required, the lower the thermal mass of the active area should be, so that the temperature adjustment can be performed with sufficient rapidity.

One advantage of the device according to the present invention is that there is virtually no increase in the volume and mass of the CO oxidation stage 3. This is of particular advantage in the case of a fuel cell system intended for mobile applications.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for the selective catalytic oxidation of carbon monoxide contained in a gas mixture flow containing hydrogen, comprising:
at least one CO oxidation stage having at least one inlet opening for feeding oxidizing gas to the gas mixture flow;
at least one flow-through body containing a catalyst and arranged in the at least one CO oxidation stage, wherein said flow-through body extends across a cross-section of the CO oxidation stage;
means for pre-setting the temperature of the flow-through body as a function of a load; and
means for feeding the oxidizing gas.

2. A device according to claim 1, wherein the flow-through body has a low thermal mass.

3. A device according to claim 1, wherein the flow-through body is thermally insulated from walls of the CO oxidation stage.

4. A device according to claim 1, wherein the flow-through body comprises a catalyst-coated fleece.

5. A device according to claim 1, wherein the flow-through body comprises a catalyst-coated mesh.

6. A device according to claim 1, wherein the flow-through body comprises a catalyst packing.

7. A device according to claim 1, wherein the means for pre-setting the temperature comprises a temperature sensor arranged on an outlet flow side of the flow-through body.

8. A device according to claim 1, wherein the means for feeding the oxidizing gas comprises a metering device.

9. A device for the selective catalytic oxidation of carbon monoxide contained in a gas mixture flow containing hydrogen, comprising:
at least one CO oxidation stage having at least one inlet opening for feeding oxidizing gas to the gas mixture flow;
at least one flow-through body containing a catalyst and arranged in the at least one CO oxidation stage, wherein said flow-through body has a length corresponding to a cross-section of the CO oxidation stage;
a temperature sensor on an outlet side of the at least one CO oxidation stage; and
an oxidizing gas metering device.

10. A device according to claim 1, wherein the flow-through body has a thermal capacity from about 5-100 Joule/Kelvin.

11. A fuel cell system comprising the device according to claim 1.
